(19) United States
(12) Patent Application Publication
(10) Pub. No.: US 2025/0015422 A1
(43) Pub. Date: Jan. 9, 2025

(54) Bipolar Storage Battery

(71) Applicants: The Furukawa Battery Co., Ltd., Yokohama (JP); Furukawa Electric Co., Ltd., Tokyo (JP)

(72) Inventors: Kenji Hirota, Iwaki (JP); Yoshinobu Taira, Iwaki (JP); Hiroki Tanaka, Tokyo (JP); Yasuo Nakajima, Tokyo (JP)

(21) Appl. No.: 18/897,677

(22) Filed: Sep. 26, 2024

Related U.S. Application Data
(63) Continuation of application No. PCT/JP2023/007098, filed on Feb. 27, 2023.

(30) Foreign Application Priority Data
Mar. 30, 2022 (JP) 2022-057592

(51) Int. Cl. H01M 50/291; H01M 4/68; H01M 10/18; H01M 50/24; H01M 50/242

(52) U.S. Cl. CPC H01M 50/291; H01M 4/685; H01M 10/18; H01M 50/24; H01M 50/242

(57) ABSTRACT

Described is a bipolar storage battery with sufficient stiffness to withstand a force of expansion of cells due to gas generated by corrosion or a force of an impact from the outside, while ensuring air tightness inside the cells and mechanical strength. The battery includes a plurality of cell members stacked with spacing, each including a positive electrode, a negative electrode, and a separator interposed therebetween. The battery includes a space forming member forming a plurality of spaces individually housing the cell members and including a substrate and a frame. The battery includes an outer reinforcing wall facing an outer wall face of the frame and extending from the substrate in a stacking direction of the cell members and the space forming member. An outer hollow space is formed between the outer reinforcing wall and the outer wall face.

### CROSS-REFERENCE TO RELATED APPLICATION(S)

This application is a continuation of PCT Application No. PCT/JP2023/007098, filed Feb. 27, 2023, the disclosure of which is incorporated herein in its entirety by reference.

### TECHNICAL FIELD

Embodiments of the present invention relate to a bipolar storage battery.

### BACKGROUND

These days, the number of power generation facilities utilizing natural energy such as sunlight and wind power is increasing. In such power generation facilities, because the amount of power generation is difficult to control, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used for economic efficiency, safety, etc. As such a conventional lead-acid storage battery, for example, one described in JP 6124894 B2 is known.

In the lead-acid storage battery described in JP 6124894 B2, a substrate (bipolar plate) made of resin is attached inside a frame (rim) made of resin having a picture frame shape. A positive lead layer and a negative lead layer are provided on one face and the other face of the substrate. A positive active material layer is adjacent to the positive lead layer. A negative active material layer is adjacent to the negative lead layer. Furthermore, a glass mat (electrolytic layer) containing an electrolyte solution is arranged inside a spacer made of resin having a picture frame shape. Then, a plurality of the frames and a plurality of the spacers are alternately stacked and assembled.

The positive lead layer and the negative lead layer are directly joined in a plurality of perforations formed in the substrate. That is, the lead-acid storage battery described in JP 6124894 B2 is a bipolar lead-acid storage battery in which a plurality of the substrates each have the perforations (communication holes) that allow one face side and the other face side to communicate with each other. A plurality of cell members are alternately stacked. Each cell member includes a positive electrode in which the positive active material layer is provided on the positive lead layer, a negative electrode in which the negative active material layer is provided on the negative lead layer, and the electrolytic layer interposed between the positive electrode and the negative electrode. The positive lead layer of one cell member and the negative lead layer of another cell member enter the inside of the perforations of the substrate and are joined, causing the cell members to be connected in series.

### SUMMARY

However, for example, in the bipolar lead-acid storage battery as described above, the positive lead layer can be corroded by sulfuric acid contained in the electrolyte solution to generate a coating film of a corrosion product (e.g., lead dioxide or lead sulfate) on a surface of the positive lead layer. Gas is generated by this process, and there is a possibility that the pressure in a cell, which is a space housing the cell member, increases due to the generated gas, causing the cell to expand.

Mechanisms for installing the bipolar lead-acid storage battery are roughly divided into a case where the cell members are stacked in a direction parallel to the vertical direction and a case where the cell members are stacked in the horizontal direction inclined by 90 degrees from the vertical direction. In any case, if the cell expands due to degradation of the battery or the like, for example, there is a possibility that the positive lead layer and the positive active material layer are separated, causing the positive active material layer to fall off of the positive lead layer. In particular, in the case where the cell members are stacked in the horizontal direction, it is considered that the positive active material layer more easily falls off of the positive lead layer due to gravity.

The fallen positive active material layer accumulates in a lower portion or a bottom portion of the bipolar lead-acid storage battery. In this state, a normal voltage cannot be maintained, which may cause deterioration in performance and reliability of the battery.

Furthermore, for example, the above-described JP 6124894 B2 illustrates that the bipolar plate and the frame can be joined by various methods. However, for example, if a force generated by the expansion of the cell is applied to a joint portion and the force becomes unexpected, the joint portion may be damaged. Further, it is also considered that an unexpected force is similarly applied to the joint portion when the bipolar lead-acid storage battery receives an impact from the outside.

When the joint portion is damaged in this manner, it becomes difficult to hold the cell member. Therefore, not only the falling-off of the positive active material layer but also a short circuit between the positive electrode side and the negative electrode side or the like may occur due to movement of each part constituting the cell member. Also in this case, the performance and reliability of the battery are deteriorated.

An object of the present invention is to provide a bipolar storage battery capable of achieving sufficient stiffness to withstand a force of expansion of cells that may occur due to gas generated by corrosion caused by sulfuric acid contained in an electrolyte solution or a force of an impact from the outside while ensuring air tightness inside the cells and mechanical strength.

A bipolar storage battery according to an aspect of the present invention includes a plurality of cell members stacked with spacing. Each of the cell members includes a positive electrode including a positive electrode current collector and a positive active material layer, a negative electrode including a negative electrode current collector and a negative active material layer, and a separator interposed between the positive electrode and the negative electrode. The bipolar storage battery further includes a space forming member forming a plurality of spaces individually housing the plurality of cell members. The space forming member includes a substrate covering at least one of the positive electrode side or the negative electrode side of each of the cell members, and a frame surrounding a side face of each of the cell members. The bipolar storage battery further includes an outer reinforcing wall facing an outer wall face of the frame and extending from the substrate in a stacking direction of the cell members and the space forming member. An outer hollow space is formed between the outer reinforcing wall and the outer wall face.

When such a configuration is adopted, it is possible to provide a bipolar storage battery capable of achieving sufficient stiffness to withstand the force of expansion of cells that may occur due to gas generated by corrosion caused by sulfuric acid contained in the electrolyte solution or the force of an impact from the outside, while ensuring air tightness inside the cells and mechanical strength.

### BRIEF DESCRIPTION OF THE DRAWINGS

FIG. 1 is a cross-sectional view illustrating a structure of a bipolar lead-acid storage battery according to an embodiment of the present invention.

FIG. 2 is an enlarged cross-sectional view illustrating a structure of a portion of the bipolar lead-acid storage battery according to an embodiment of the present invention.

FIG. 3 is an explanatory view illustrating another structure of an outer reinforcing wall according to an embodiment of the present invention.

FIG. 4 is an explanatory view illustrating still another structure of the outer reinforcing wall according to an embodiment of the present invention.

### DETAILED DESCRIPTION

Hereinafter, embodiments of the present invention will be described with reference to the drawings. Note that the embodiments described below illustrate examples of the present invention. Furthermore, various changes or improvements can be added to each of these embodiments, and a mode to which such changes or improvements are added can also be included in the present invention. These embodiments and modifications thereof are included in the scope of the invention described in the claims and their equivalents. Note that, hereinafter, a lead-acid storage battery will be described as an example from among various storage batteries.

### Overall Configuration

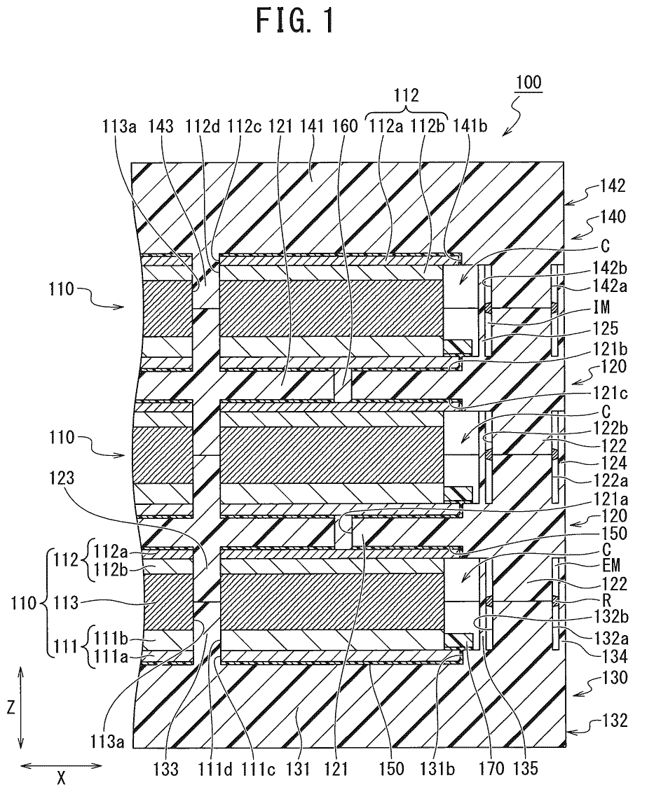

First, an overall configuration of a bipolar lead-acid storage battery in an embodiment of the present invention is described. FIG. 1 is a cross-sectional view illustrating a structure of a bipolar lead-acid storage battery 100 according to an embodiment of the present invention.

As illustrated in FIG. 1, the bipolar lead-acid storage battery 100 includes a plurality of cell members 110, a plurality of bipolar plates 120 (space forming members), a first end plate 130 (space forming member), and a second end plate 140 (space forming member).

Note that the bipolar plate 120, the first end plate 130, and the second end plate 140 are appropriately referred to as “plates P” when collectively described in the description.

Here, although FIG. 1 illustrates the bipolar lead-acid storage battery 100 in which three cell members 110 are stacked, the number of cell members 110 is determined by battery design. Furthermore, the number of bipolar plates 120 is determined according to the number of cell members 110.

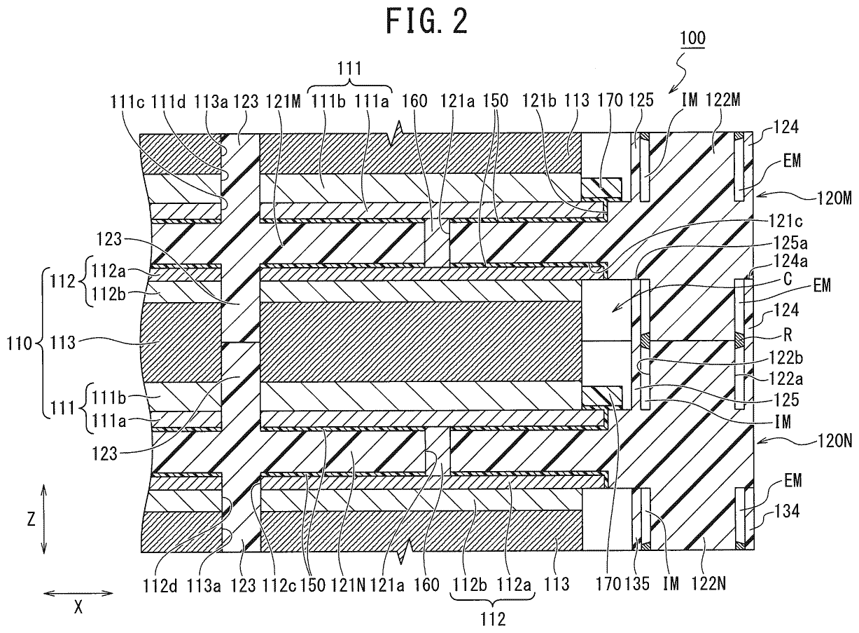

Note that, in the following, as illustrated in FIG. 1 and FIG. 2 described later, a direction that is parallel to the vertical direction and is a stacking direction of the cell members 110 is defined as a Z direction (the up-down direction in FIG. 1). Directions perpendicular to the Z direction and perpendicular to each other are defined as an X direction and a Y direction.

The cell member 110 includes a positive electrode 111, a negative electrode 112, and an electrolytic layer or separator 113. The positive electrode 111 includes a positive electrode lead foil 111a, which is a positive electrode current collector made of lead or a lead alloy, and a positive active material layer 111b. The negative electrode 112 includes a negative electrode lead foil 112a, which is a negative electrode current collector made of lead or a lead alloy, and a negative active material layer 112b.

The positive electrode lead foil 111a is provided on one face (in FIG. 1, a face facing upward in the paper surface) of the bipolar plate 120 by an adhesive 150, which will be described later, provided between the one face of the bipolar plate 120 and the positive electrode lead foil 111a. Therefore, an adhesive layer (e.g., the adhesive 150), the positive electrode lead foil 111a, and the positive active material layer 111b are stacked in this order on the one face of the bipolar plate 120.

On the other hand, the negative electrode lead foil 112a is provided on the other face (in FIG. 1, a face facing downward in the paper surface) of the bipolar plate 120 by the adhesive 150, which will be described later, provided between the other face of the bipolar plate 120 and the negative electrode lead foil 112a. Therefore, an adhesive layer (e.g., the adhesive 150), the negative electrode lead foil 112a, and the negative active material layer 112b are stacked in this order on the other face of the bipolar plate 120. The positive electrode 111 and the negative electrode 112 are electrically connected via a conductor 160 to be described later.

The separator 113 includes, for example, a glass fiber mat impregnated with an electrolyte solution containing sulfuric acid. The separator 113 is provided to be sandwiched between the positive active material layer 111b provided on one of the bipolar plates 120 facing each other and the negative active material layer 112b provided on the other bipolar plate 120. In the cell member 110, the positive electrode lead foil 111a, the positive active material layer 111b, the separator 113, the negative active material layer 112b, and the negative electrode lead foil 112a are stacked in this order.

In the bipolar lead-acid storage battery 100 having such a configuration, as described above, the bipolar plates 120, the positive electrode lead foil 111a, the positive active material layer 111b, the negative electrode lead foil 112a, and the negative active material layer 112b collectively constitute a bipolar electrode. A bipolar electrode refers to an electrode having functions of both the positive electrode and the negative electrode in one electrode.

In the bipolar lead-acid storage battery 100, the plurality of cell members 110, each of which is formed by interposing the separator 113 between the positive electrode 111 and the negative electrode 112, and the plurality of bipolar plates 120, provided in pairs to sandwich each of the cell members 110, are stacked. The outermost layer is assembled by the first end plate 130 and the second end plate 140 to have a battery configuration in which the cell members 110 are connected in series.

Dimensions in the X direction and the Y direction of the positive electrode lead foil 111a are larger than dimensions in the X direction and the Y direction of the positive active material layer 111b. Similarly, dimensions in the X direction and the Y direction of the negative electrode lead foil 112a are larger than dimensions in the X direction and the Y direction of the negative active material layer 112b. Furthermore, for a dimension in the Z direction (thickness), the positive electrode lead foil 111a is larger (thicker) than the negative electrode lead foil 112a, and the positive active material layer 111b is larger (thicker) than the negative active material layer 112b.

The plurality of cell members 110 are arranged with spacing in a stacked manner in the Z direction, and the substrates 121 of the bipolar plates 120 are arranged in portions of the spacing. That is, the plurality of cell members 110 are stacked in a state where a substrate 121 of the bipolar plate 120 is sandwiched between the cell members 110.

Thus, the plurality of bipolar plates 120, the first end plate 130, and the second end plate 140 are space forming members for forming a plurality of spaces C (cells) individually housing the plurality of cell members 110.

That is, the bipolar plate 120 is the space forming member including the substrate 121, which covers both the positive electrode 111 side and the negative electrode 112 side of the cell member 110 and has a rectangular planar shape, and a frame 122 surrounding a side face of the cell member 110 and covering the four end faces of the substrate 121.

Here, the frame 122 has an outer wall face 122a and an inner wall face 122b. The inner wall face 122b faces the side face of the cell member 110. In other words, a part of the space C for housing the cell member 110 is defined by the inner wall face 122b. The outer wall face 122a forms a part of the outer surface of the bipolar lead-acid storage battery 100.

Furthermore, as illustrated in FIG. 1, the bipolar plate 120 further includes a column 123 perpendicularly protruding from both faces of the substrate 121. The number of columns 123 protruding from each face of the substrate 121 may be one or more.

In the Z direction, a dimension of the frame 122 is larger than a dimension (thickness) of the substrate 121, and a dimension between protruding end faces of the column 123 is the same as the dimension of the frame 122. The plurality of bipolar plates 120 are stacked such that the frames 122 and the columns 123 are in contact with each other, whereby the space C is formed between the substrate 121 and the substrate 121. The dimension in the Z direction of the space C is held by the columns 123 in contact with each other.

Here, FIG. 2 is an enlarged cross-sectional view illustrating a structure of a portion of the bipolar lead-acid storage battery 100 according to the embodiment of FIG. 1. In FIG. 2, the cell member 110 sandwiched between two bipolar plates 120 is illustrated at the center.

Furthermore, out of the adjacent bipolar plates 120 in FIG. 2, for convenience of description, a bipolar plate on an upper side of the drawing is referred to as a bipolar plate 120M, and a bipolar plate on a lower side thereof is referred to as a bipolar plate 120N. Note that the following description will be given with the bipolar plate 120N as a reference.

In the bipolar lead-acid storage battery 100, an outer reinforcing wall 124 is arranged at a position facing the outer wall face 122a of the frame 122. That is, as illustrated in FIG. 2, a substrate 121N of the bipolar plate 120N is formed to extend beyond a frame 122N in the X direction. Furthermore, the outer reinforcing wall 124 is formed to extend upward in the Z direction from such an extended portion.

The outer reinforcing wall 124 is formed to be longer than an upward length of the frame 122N in the Z direction as viewed from the extended portion of the substrate 121N. Specifically, the outer reinforcing wall 124 is formed to extend upward beyond a joining position between a frame 122M of the adjacent bipolar plate 120M and the frame 122N of the bipolar plate 120N.

An end 124a of the outer reinforcing wall 124 in a direction extending upward in the Z direction is arranged in the vicinity of the adjacent substrate 121M. That is, the end 124a extends to the vicinity of the substrate 121M of the bipolar plate 120M.

The bipolar plate 120M and the bipolar plate 120N illustrated in FIG. 2 are joined to each other by vibration welding or the like to be described later, but in this state, the end 124a is at a position facing the substrate 121M in the vicinity thereof. That is, the outer reinforcing wall 124 is formed to have a length in consideration of a welding depth in the vibration welding or the like. The outer reinforcing wall 124 is formed such that a length in the Z direction of the outer reinforcing wall 124 before joining is longer than a length in the Z direction of the outer reinforcing wall 124 after joining.

Note that, here, the “vicinity” refers to where the end 124a is at a position separated from the facing substrate 121M without contacting the facing substrate 121M. Furthermore, a state where the end 124a is in contact with the facing substrate 121M where the bipolar plate 120M and the bipolar plate 120N are joined is also included.

Because the outer reinforcing wall 124 has such a shape and is provided at such a position, an outer hollow space EM is formed between the outer reinforcing wall 124 and the outer wall face 122a of the frames (i.e., the frame 122M and the frame 122N) of the facing bipolar plates (i.e., the bipolar plate 120M and the bipolar plate 120N). That is, the outer hollow space EM refers to a space formed between the outer reinforcing wall 124 and the outer wall faces 122a of the frame 122M and the frame 122N.

Further, the bipolar lead-acid storage battery 100 includes an inner reinforcing wall 125 having a shape similar to that of the outer reinforcing wall 124. That is, as illustrated in FIGS. 1 and 2, the inner reinforcing wall 125 is provided inside the space C between the inner wall face 122b of the frame 122 and the cell member 110.

That is, as illustrated in FIG. 2, the inner reinforcing wall 125 is formed between the frame 122N in the substrate 121N of the bipolar plate 120N and the cover plate 170. The inner reinforcing wall 125 is formed to extend upward in the Z direction from the substrate 121N.

Similar to the outer reinforcing wall 124, the inner reinforcing wall 125 is formed to be longer than an upward length of the frame 122N in the Z direction as viewed from the substrate 121N. Specifically, the inner reinforcing wall 125 is formed to extend upward beyond a joining position between the frame 122M of the adjacent bipolar plate 120M and the frame 122N of the bipolar plate 120N.

An end 125a of the inner reinforcing wall 125 in a direction extending upward in the Z direction is arranged in the vicinity of the adjacent substrate 121M. That is, the end 125a extends to the vicinity of the substrate 121M of the bipolar plate 120M. Note that the meaning of the “vicinity” is as described above.

A length of the inner reinforcing wall 125 in the Z direction is formed in consideration of a welding depth in vibration welding or the like. The length in the Z direction of the inner reinforcing wall 125 before joining is formed to be longer than the length in the Z direction of the inner reinforcing wall 125 after joining.

Because the inner reinforcing wall 125 has such a shape and is provided at such an arrangement position, an inner hollow space IM is formed between the inner reinforcing wall 125 and the inner wall face 122b of the frames (i.e., the frame 122M and the frame 122N) of the facing bipolar plates (i.e., the bipolar plate 120M and the bipolar plate 120N).

Note that sizes of the outer hollow space EM and the inner hollow space IM, that is, a distance between the outer reinforcing wall 124 and the outer wall face 122a and a distance between the inner reinforcing wall 125 and the inner wall face 122b, can be set to any length. Although the distances are drawn to be substantially equal in FIGS. 1 and 2, the distances may be different from each other.

Because the outer hollow space EM and the inner hollow space IM are provided, it is possible to weaken a force applied from the inside or the outside of the bipolar lead-acid storage battery 100 to a joint portion between the frames 122 of the adjacent bipolar plates 120 or a joint portion between the bipolar plate 120 and the first end plate 130 or the second end plate 140 to be described later. Therefore, stiffness and impact resistance of the bipolar lead-acid storage battery 100 can be ensured.

Furthermore, heat insulating properties may be improved by forming the outer hollow space EM and the inner hollow space IM, and thus, the bipolar lead-acid storage battery 100 is less likely to be affected by an ambient temperature during operation. This contributes to stabilization of performance during the operation of the battery.

The inner hollow space IM may serve, for example, as a cushioning material against a pressure change inside the space C housing the cell member 110 when the inner hollow space IM is provided, and thus, robustness increases.

As will be described later, the frames are joined to each other by, for example, vibration welding, but a burr is generated at the joint portions of the respective plates P at the time of joining. However, the burr generated by vibration welding or the like can be made invisible from the outside of the bipolar lead-acid storage battery 100 by forming the outer reinforcing wall 124. As a result, a surface on the outer side of the bipolar lead-acid storage battery 100 can be seen to be smooth, and a more appealing design for a bipolar storage battery can be provided.

There is still a possibility that the burr generated at the time of joining injures (e.g., damages) a finger of a carrier at the time of carrying the bipolar lead-acid storage battery 100, for example, due to its shape. During operation of the bipolar lead-acid storage battery 100, a lid (not illustrated) is separately attached, and it is important to ensure airtightness between the lid and a stacked body. However, if the burr is present, it may be difficult to seal the lid in an airtight manner.

Therefore, it may be necessary to shave the burr, but the occurrence of the above-described adverse effects can be avoided by providing the outer reinforcing wall 124. Because it is not necessary to provide a step of scraping (i.e., shaving) the burr in this manner, it is possible to reduce steps related to the manufacture of the bipolar lead-acid storage battery 100. Furthermore, the manufacturing steps can be simplified, the takt time can be shortened, and the manufacturing cost can be reduced.

Note that a state where the outer hollow space EM and the inner hollow space IM are provided by forming the outer reinforcing wall 124 and the inner reinforcing wall 125 is illustrated in the bipolar lead-acid storage battery 100 illustrated in FIGS. 1 and 2. However, both the outer hollow space EM and the inner hollow space IM are not necessarily provided. That is, it is sufficient to provide at least the outer hollow space EM between the outer reinforcing wall 124 and the outer wall face 122a.

It is also possible to use the burr, generated by joining the plates P adjacent to each other, as an internal reinforcing member R. That is, as illustrated in FIG. 1 or 2, the internal reinforcing member R is formed in the outer hollow space EM or the joint portion between the adjacent plates P inside the inner hollow space IM.

Note that the internal reinforcing member R may be formed in both the outer hollow space EM and the inner hollow space IM, or the internal reinforcing member R may be formed in any one of the hollow spaces.

It is considered that a size of the internal reinforcing member R to be formed varies depending on each joint portion. However, in any case, the internal reinforcing member R formed inside the outer hollow space EM or the inner hollow space IM grows from the joint portion toward the outer reinforcing wall 124 or the inner reinforcing wall 125.

Because the internal reinforcing member R is formed at the joint portion between the plates P joined to face each other in this manner, tensile strength, that is, a force against a force by which the plates P are separated from each other in the Z direction is improved. Therefore, the plates P are more firmly joined to each other.

Furthermore, the internal reinforcing member R is formed so that the internal reinforcing member R is brought into contact with or joined to both or any one of the outer reinforcing wall 124 and the inner reinforcing wall 125. As a result, a force against a force applied, for example, from the outside to the inside of the bipolar lead-acid storage battery 100 or from the space C to the outside, that is, a force acting in the X direction, is improved. Therefore, even when such a force is applied to the bipolar lead-acid storage battery 100, it is possible to absorb an impact thereof or bear a force due to expansion.

As described above, the outer reinforcing wall 124 illustrated in FIGS. 1 and 2 is provided to extend from the bipolar plate 120N, for example, such that the end 124a thereof is located in the vicinity of the substrate 121M of the bipolar plate 120M joined to the bipolar plate 120N.

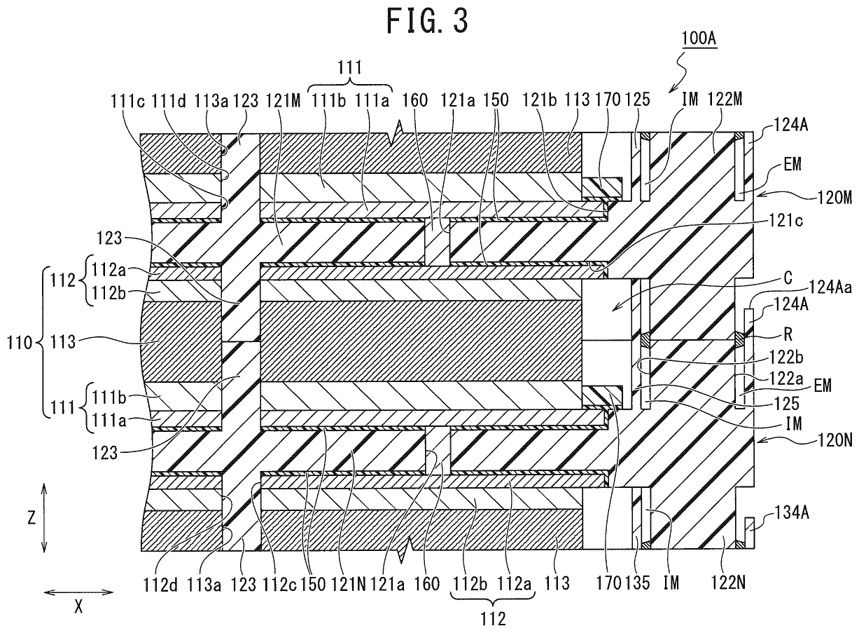

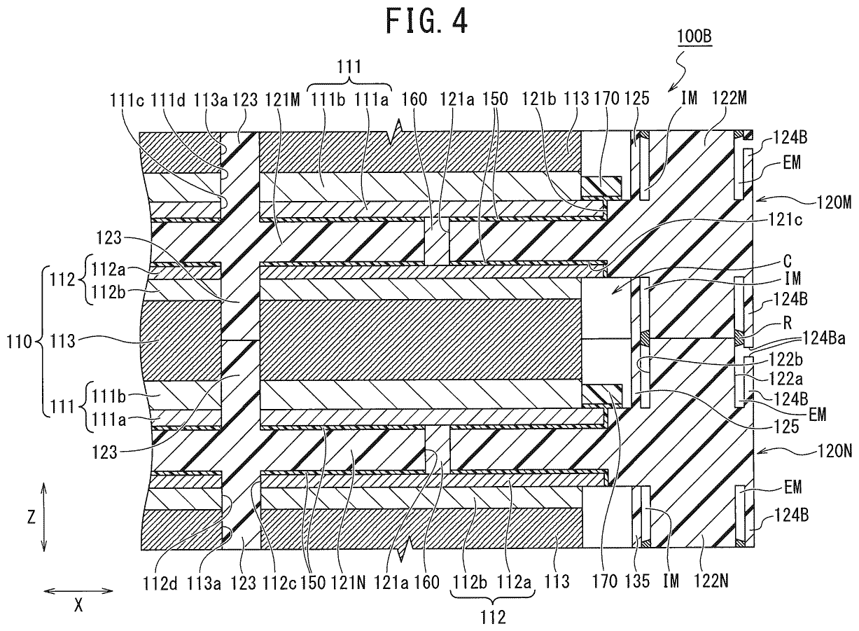

However, the shape of the outer reinforcing wall 124 is not necessarily the shape described above. Hereinafter, other shapes of the outer reinforcing wall 124 will be described with reference to FIGS. 3 and 4.

FIGS. 3 and 4 are explanatory views illustrating other structures of the outer reinforcing wall 124 according to an embodiment of the present invention. Note that, also in FIGS. 3 and 4, description will be given assuming that bipolar plates illustrated to be adjacent to each other are the bipolar plate 120M and the bipolar plate 120N, respectively.

FIG. 3 is an enlarged cross-sectional view illustrating a structure of a portion of a bipolar lead-acid storage battery 100A according to an embodiment. In the bipolar lead-acid storage battery 100A, a shape of an outer reinforcing wall 124A is different from that of the outer reinforcing wall 124 described above.

The outer reinforcing wall 124A illustrated in FIG. 3 is formed to extend upward in the Z direction from the substrate 121N of the bipolar plate 120N. Note that an end 124Aa thereof faces the substrate 121M of the bipolar plate 120M and is long enough to be located away from the substrate 121M.

Although the positional relationship between the end 124Aa and the substrate 121M is in a state of being separated from each other in this manner, an arrangement position of the end 124Aa is formed to be at least above a joint portion of the frames (i.e., the frame 122M and the frame 122N) of the bipolar plates (i.e., the bipolar plate 120M and the bipolar plate 120N) in the Z direction.

Even if the outer reinforcing wall 124A is formed in the shape as illustrated in FIG. 3, all the above effects exhibited by providing the outer reinforcing wall 124 can be obtained.

Next, FIG. 4 is an enlarged cross-sectional view illustrating a structure of a portion of a bipolar lead-acid storage battery 100B according to an embodiment. In the bipolar lead-acid storage battery 100B, a shape of an outer reinforcing wall 124B is different from those of the outer reinforcing wall 124 described above.

The outer reinforcing wall 124B illustrated in FIG. 4 is formed to extend to both the upper side and the lower side in the Z direction with the substrate 121N as the center. An end 124Ba, which is an extended distal end, faces the end 124Ba of the outer reinforcing wall 124B formed in the adjacent plate P.

A position of the end 124Ba of the outer reinforcing wall 124B in the Z direction is set to cover a joint portion of frames between the adjacent plates P. In FIG. 4, in any of the outer reinforcing walls 124B provided in the bipolar plate 120M and the bipolar plate 120N, the outer reinforcing wall 124B extending upward in the Z direction does not reach the above-described joint portion. Furthermore, the outer reinforcing wall 124B extending downward in the Z direction is formed to cover the joint portion.

Even if the outer reinforcing wall 124B is formed in the shape as illustrated in FIG. 4 described above, it is possible to obtain all the above effects achieved by providing the outer reinforcing wall 124 or the outer reinforcing wall 124A.

The substrate 121, the frame 122, the column 123, the outer reinforcing wall 124, and the inner reinforcing wall 125 constituting the bipolar plate 120 are integrally formed of, for example, a thermoplastic resin. Examples of the thermoplastic resin forming the bipolar plate 120 include an acrylonitrile-butadiene-styrene copolymer (ABS) resin or polypropylene. These thermoplastic resins are excellent in moldability and in sulfuric acid resistance. Hence, even when the electrolyte solution contacts the bipolar plate 120, decomposition, deterioration, corrosion, and the like hardly occur in the bipolar plate 120.

Through hole 111c is formed in the positive electrode lead foil 111a. Through hole 111d is formed in the positive active material layer 111b. Through hole 112c is formed in the negative electrode lead foil 112a. Through hole 112d is formed in the negative active material layer 112b. Through hole 113a is formed in the separator 113. Through holes 111c, 111d, 112c, 112d, and 113a allow the column 123 to penetrate therethrough.

As illustrated in FIG. 1 or 2, the substrate 121 of the bipolar plate 120 has a plurality of through holes 121a penetrating the plate surface. A first recess 121b is formed on one face of the substrate 121, and a second recess 121c is formed on the other face. A depth of the first recess 121b is deeper than a depth of the second recess 121c. Dimensions in the X direction and the Y direction of the first recess 121b and the second recess 121c are made to correspond to the dimensions in the X direction and the Y direction of the positive electrode lead foil 111a and the negative electrode lead foil 112a.

The substrate 121 of the bipolar plate 120 is arranged between adjacent cell members 110 in the Z direction. The positive electrode lead foil 111a of the cell member 110 is arranged in the first recess 121b of the substrate 121 of the bipolar plate 120 via the adhesive 150. Furthermore, the negative electrode lead foil 112a of the cell member 110 is arranged in the second recess 121c of the substrate 121 of the bipolar plate 120 via the adhesive 150.

The conductor 160 is arranged in the through hole 121a of the substrate 121 of the bipolar plate 120. Both end faces of the conductor 160 are in contact with and coupled to the positive electrode lead foil 111a and the negative electrode lead foil 112a. That is, the positive electrode lead foil 111a and the negative electrode lead foil 112a are electrically connected by the conductor 160. As a result, each of the plurality of cell members 110 is electrically connected in series.

On an outer edge portion of the positive electrode lead foil 111a, a cover plate 170 for covering the outer edge portion is provided. The cover plate 170 is, for example, a thin plate-shaped frame and has a rectangular inner shape line and a rectangular outer shape line. An inner edge portion of the cover plate 170 overlaps with the outer edge portion of the positive electrode lead foil 111a, and an outer edge portion of the cover plate 170 overlaps with a peripheral edge portion of the first recess 121b of one face of the substrate 121.

That is, the rectangle forming the inner shape line of the cover plate 170 is smaller than a rectangle forming an outer shape line of the positive electrode lead foil 111a, and the rectangle forming the outer shape line of the cover plate 170 is larger than a rectangle forming an opening face of the first recess 121b.

The adhesive 150 runs around from an end face of the positive electrode lead foil 111a to an outer edge portion on the opening side of the first recess 121b, and the adhesive 150 is arranged between the inner edge portion of the cover plate 170 and the outer edge portion of the positive electrode lead foil 111a. Furthermore, the adhesive 150 is also arranged between the outer edge portion of the cover plate 170 and one face of the substrate 121.

That is, the cover plate 170 is fixed by the adhesive 150 over the peripheral edge portion of the first recess 121b on one face of the substrate 121 and the outer edge portion of the positive electrode lead foil 111a. Thus, the outer edge portion of the positive electrode lead foil 111a is covered with the cover plate 170 also in a boundary portion with the peripheral edge portion of the first recess 121b.

Note that, although not illustrated in FIG. 1, an outer edge portion of the negative electrode lead foil 112a may also be covered with a cover plate similar to the cover plate 170 covering an outer edge portion of the positive electrode lead foil 111a. Furthermore, the cover plate has been described as an example of a thin plate-shaped frame, but, for example, a tape-shaped object or the like may be used as long as the cover plate has electrolyte solution resistance (e.g., sulfuric acid resistance).

As illustrated in FIG. 1, the first end plate 130 is a space forming member including a substrate 131 covering the positive electrode side of the cell member 110 and a frame 132 surrounding a side face of the cell member 110. Furthermore, a column 133 vertically protrudes from one face of the substrate 131 (a face facing the substrate 121 of the bipolar plate 120 arranged most on the positive electrode side).

The substrate 131 has a rectangular planar shape. Four end faces of the substrate 131 are covered with the frame 132. The substrate 131, the frame 132, and the column 133 are integrally formed of, for example, the above-described thermoplastic resin. Note that the number of columns 133 protruding from each face of the substrate 131 may be one or more. However, the number corresponds to the number of columns 133 of the bipolar plate 120 to be brought into contact with the columns 123.

In the Z direction, a dimension of the frame 132 is larger than a dimension (thickness) of the substrate 131, and a dimension between protruding end faces of the column 133 is the same as the dimension of the frame 132. The first end plate 130 is stacked such that the frame 132 and the column 133 are in contact with the frame 122 and the column 123 of the bipolar plate 120 arranged on the outermost side (e.g., the positive electrode side).

Thus, the space C is formed between the substrate 121 of the bipolar plate 120 and the substrate 131 of the first end plate 130. Furthermore, a dimension in the Z direction of the space C is held by the column 123 of the bipolar plate 120 and the column 133 of the first end plate 130 in contact with each other.

The through holes 111c, 111d, and 113a allowing the column 133 to penetrate are formed in the positive electrode lead foil 111a, the positive active material layer 111b, and the separator 113 of the cell member 110 arranged on the outermost side (e.g., the positive electrode side), respectively.

A recess 131b is formed on one face of the substrate 131 of the first end plate 130. Dimensions in the X direction and the Y direction of the recess 131b are made to correspond to the dimensions in the X direction and the Y direction of the positive electrode lead foil 111a.

The positive electrode lead foil 111a of the cell member 110 is arranged in the recess 131b of the substrate 131 of the first end plate 130 via the adhesive 150. Furthermore, the cover plate 170 is fixed to one face side of the substrate 131 by the adhesive 150 like on the substrate 121 of the bipolar plate 120. As a result, the outer edge portion of the positive electrode lead foil 111a is covered with the cover plate 170 also in a boundary portion with a peripheral edge portion of the recess 131b.

Furthermore, the first end plate 130 includes a positive electrode terminal (not illustrated in FIG. 1), which is electrically connected to the positive electrode lead foil 111a in the recess 131b.

Further, as illustrated in FIGS. 1 and 2, the first end plate 130 is also provided with an outer reinforcing wall 134 and an inner reinforcing wall 135. Structures of the outer reinforcing wall 134 and the inner reinforcing wall 135 are similar to those of the outer reinforcing wall 124 and the inner reinforcing wall 125 described above. Alternatively, structures of the outer reinforcing wall 124A or the outer reinforcing wall 124B described with reference to FIGS. 3 and 4 can also be adopted.

The second end plate 140 is a space forming member including a substrate 141 covering the negative electrode side of the cell member 110 and a frame 142 surrounding a side face of the cell member 110. Furthermore, a column 143 vertically protrudes from one face of the substrate 141 (a face facing the substrate 121 of the bipolar plate 120 arranged most on the negative electrode side).

The substrate 141 has a rectangular planar shape. Four end faces of the substrate 141 are covered with the frame 142. The substrate 141, the frame 142, and the column 143 are integrally formed of, for example, the above-described thermoplastic resin. Note that the number of columns 143 protruding from each face of the substrate 141 may be one or more. However, the number corresponds to the number of columns 123 of the bipolar plate 120 to be brought into contact with the columns 143.

In the Z direction, a dimension of the frame 142 is larger than a dimension (thickness) of the substrate 141, and a dimension between protruding end faces of the two columns 143 is the same as the dimension of the frame 142. The second end plate 140 is stacked such that the frame 142 and the column 143 are in contact with the frame 122 and the column 123 of the bipolar plate 120 arranged on the outermost side (e.g., the negative electrode side).

Thus, the space C is formed between the substrate 121 of the bipolar plate 120 and the substrate 141 of the second end plate 140. Furthermore, a dimension in the Z direction of the space C is held by the column 123 of the bipolar plate 120 and the column 143 of the second end plate 140 in contact with each other.

The through holes 112c, 112d, and 113a allowing the column 143 to penetrate are formed in the negative electrode lead foil 112a, the negative active material layer 112b, and the separator 113 of the cell member 110 placed on the outermost side (e.g., the negative electrode side), respectively.

A recess 141b is formed on one face of the substrate 141 of the second end plate 140. Dimensions in the X direction and the Y direction of the recess 141b are made to correspond to the dimensions in the X direction and the Y direction of the negative electrode lead foil 112a.

The negative electrode lead foil 112a of the cell member 110 is arranged in the recess 141b of the substrate 141 of the second end plate 140 via the adhesive 150. Furthermore, the second end plate 140 includes a negative electrode terminal (not illustrated in FIG. 1), which is electrically connected to the negative electrode lead foil 112a in the recess 141b.

Here, the second end plate 140 is not provided with an outer reinforcing wall or an inner reinforcing wall. This is because it is difficult to provide these reinforcing walls due to the entire structure of the bipolar lead-acid storage battery 100. As illustrated in FIG. 1, only the outer reinforcing wall 124 and the inner reinforcing wall 125 provided on the bipolar plate 120 are arranged adjacent to the vicinity of the substrate 141.

Of course, the substrate 141 is formed to extend in the X direction at a position facing the end 124a of the outer reinforcing wall 124, and the end 124a of the outer reinforcing wall 124 is arranged in the vicinity thereof.

Note that the outer reinforcing wall 124 and the inner reinforcing wall 125 have been described as above with reference to FIGS. 1 to 3. The outer reinforcing wall 124 and the inner reinforcing wall 125 are formed to extend upward in the Z direction from the plate P stacked on the lower side in the Z direction.

However, regarding the extending direction in the Z direction, the outer reinforcing wall 124 and the inner reinforcing wall 125 may be formed to extend downward in the Z direction instead of upward in the Z direction. Even when the outer reinforcing wall 124 and the inner reinforcing wall 125 are provided as described above, the outer hollow space EM and the inner hollow space IM are formed, and the respective effects as described above can be obtained.

When joining the bipolar plates 120 facing each other, the first end plate 130 and the facing bipolar plate 120, or the second end plate 140 and the facing bipolar plate 120, various welding methods such as vibration welding, ultrasonic welding, or hot plate welding can be employed. Vibration welding is performed by vibrating faces to be joined while pressurizing the faces at the time of joining and has a fast cycle of welding and good reproducibility. Therefore, vibration welding is more preferably used.

Note that objects to be welded include not only frames but also the respective columns arranged in facing positions on facing bipolar plates 120, the first end plate 130, and the second end plate 140.

As described above, the lengths of the outer reinforcing wall 124 and the inner reinforcing wall 125 in the Z direction are set as follows. That is, for example, as illustrated in FIGS. 1 and 2, the setting is performed such that each of the end 124a and the end 125a is arranged in the vicinity of the substrate of the facing plate P when welding is completed.

Hereinabove, the shapes, lengths, and the like of the outer reinforcing wall 124 and the inner reinforcing wall 125 have been described with reference to FIGS. 1 to 4. Note that thicknesses of the outer reinforcing wall 124 and the inner reinforcing wall 125, that is, lengths of the reinforcing walls in the X direction, are preferably about 1 mm to 3 mm, for example.

The outer reinforcing wall 124 is preferably arranged such that a thickness of the outer hollow space EM, that is, a distance between the outer reinforcing wall 124 and the outer wall face 122a of the frame 122 in the X direction is, for example, about 0.5 mm to 2 mm. Furthermore, the inner reinforcing wall 125 is preferably arranged such that a thickness of the inner hollow space IM, that is, a distance between the inner reinforcing wall 125 and the inner wall face 122b of the frame 122 in the X direction is, for example, about 0.5 mm to 2 mm.

Further, for example, the facing bipolar plates 120 are joined to each other by vibration welding as described above. In this case, a width when the vibration welding is performed on the frame 122 is, for example, between 35 mm and 55 mm.

### Manufacturing Method

The bipolar lead-acid storage battery 100 of this embodiment can be manufactured by, for example, a method including each of steps to be described hereinafter.

Step of Producing Bipolar Plate Equipped with Positive Electrode Lead Foil and Negative Electrode Lead Foil

First, the bipolar plate 120 is prepared. In the bipolar plate 120, as described above, the outer reinforcing wall 124 and the inner reinforcing wall 125 are formed on the substrate 121.

The substrate 121 of the bipolar plate 120 is placed on a worktable with the first recess 121b side facing upward. Then, the adhesive 150 is applied to the first recess 121b, and the positive electrode lead foil 111a is placed in the first recess 121b. At this time, the column 123 of the bipolar plate 120 is set to pass through the through hole 111c of the positive electrode lead foil 111a. The adhesive 150 is cured to attach the positive electrode lead foil 111a to one face of the substrate 121.

Next, the substrate 121 is placed on the worktable with the second recess 121c side facing upward, and the conductor 160 is inserted into the through hole 121a. Then, the adhesive 150 is applied to the second recess 121c, and the negative electrode lead foil 112a is placed in the second recess 121c. At this time, the column 123 of the bipolar plate 120 is set to pass through the through hole 112c of the negative electrode lead foil 112a. The adhesive 150 is cured to attach the negative electrode lead foil 112a to the other face of the substrate 121.

Next, the substrate 121 is placed on the worktable with the first recess 121b side facing upward. Then, the adhesive 150 is applied onto an outer edge portion of the positive electrode lead foil 111a and an upper face of the substrate 121 to be an edge portion of the first recess 121b, the cover plate 170 is placed thereon, and the adhesive 150 is cured. Thus, the cover plate 170 is fixed over the outer edge portion of the positive electrode lead foil 111a and a portion of the substrate 121 continuous to the outside thereof (a peripheral edge portion of the first recess 121b).

Next, resistance welding is performed to connect the conductor 160, the positive electrode lead foil 111a, and the negative electrode lead foil 112a. Thus, the bipolar plate 120 equipped with positive electrode lead foil and negative electrode lead foil is obtained. A desired number of the bipolar plates 120 equipped with positive electrode lead foil and negative electrode lead foil are prepared.

Step of Producing End Plate Equipped with Positive Electrode Lead Foil

First, the first end plate 130 provided with the outer reinforcing wall 134 and the inner reinforcing wall 135 as illustrated in FIG. 1 and the like is prepared. The substrate 131 of the first end plate 130 is placed on a worktable with the recess 131b side facing upward.

Then, the adhesive 150 is applied to the recess 131b, the positive electrode lead foil 111a is placed in the recess 131b, and the adhesive 150 is cured. At this time, the column 133 of the end plate 130 is set to pass through the through hole 111c of the positive electrode lead foil 111a. The adhesive 150 is cured to attach the positive electrode lead foil 111a to one face of the substrate 131.

Next, the adhesive 150 is applied onto an outer edge portion of the positive electrode lead foil 111a and an upper face of the substrate 131 to be an edge portion of the recess 131b. The cover plate 170 is placed on the adhesive 150, and the adhesive 150 is cured. Thus, the cover plate 170 is fixed over the outer edge portion of the positive electrode lead foil 111a and a portion of the substrate 131 continuous to the outside thereof. Thus, an end plate equipped with a positive electrode lead foil is obtained.

Step of Producing End Plate Equipped with Negative Electrode Lead Foil

First, the second end plate 140 as illustrated in FIG. 1 and the like is prepared. The outer reinforcing wall 124 and the inner reinforcing wall 125 are not formed on the second end plate 140. Meanwhile, because the end 124a of the outer reinforcing wall 124 of the adjacent bipolar plates 120 to be joined is arranged in the vicinity thereof, the substrate 141 thereof is formed to extend outward in the X direction (in FIG. 1, to the right side of the drawing).

The substrate 141 of this second end plate 140 is placed on a worktable with the recess 141b side facing upward. Then, the adhesive 150 is applied to the recess 141b, the negative electrode lead foil 112a is placed in the recess 141b, and the adhesive 150 is cured. At this time, the column 143 of the second end plate 140 is set to pass through the through hole 112c of the negative electrode lead foil 112a. The adhesive 150 is cured to obtain the second end plate 140 equipped with the negative electrode lead foil 112a attached to one face of the substrate 141.

### Step of Stacking and Joining Plates

First, the first end plate 130 to which the positive electrode lead foil 111a and the cover plate 170 are fixed is placed on a worktable with the positive electrode lead foil 111a facing upward. Then, the positive active material layer 111b is placed in the cover plate 170 and is positioned on the positive electrode lead foil 111a. At this time, the column 133 of the first end plate 130 is set to pass through the through hole 111d of the positive active material layer 111b. Next, the separator 113 and the negative active material layer 112b are placed on the positive active material layer 111b.

Next, on the first end plate 130 in this state, the negative electrode lead foil 112a side of the bipolar plate 120 equipped with positive electrode lead foil and negative electrode lead foil is placed to face downward. At this time, the column 123 of the bipolar plate 120 is set to pass through the through hole 113a of the separator 113 and the through hole 112d of the negative active material layer 112b, and the column 123 is positioned on the column 133 of the first end plate 130. Then, the frame 122 of the bipolar plate 120 is put on the frame 132 of the first end plate 130.

In this state, the first end plate 130 is fixed, and vibration welding is performed while the bipolar plate 120 is vibrated in a diagonal direction of the substrate 121. Thus, the frame 122 of the bipolar plate 120 is joined onto the frame 132 of the first end plate 130. Furthermore, the column 123 of the bipolar plate 120 is joined onto the column 133 of the first end plate 130.

As a result, the bipolar plate 120 is joined onto the first end plate 130 to form a coupled body. A state is formed in which the cell member 110 is arranged in the space C formed by the first end plate 130 and the bipolar plate 120, and the positive electrode lead foil 111a is exposed on an upper face of the bipolar plate 120.

Next, the positive active material layer 111b, the separator 113, and the negative active material layer 112b are placed in this order on the coupled body. After that, another bipolar plate 120 equipped with positive electrode lead foil and negative electrode lead foil is placed with the negative electrode lead foil 112a side facing downward.

In this state, the coupled body is fixed, and vibration welding is performed while another bipolar plate 120 equipped with positive electrode lead foil and negative electrode lead foil is vibrated in a diagonal direction of the substrate 121. This stacking and vibration welding step is continually performed until the required number of bipolar plates 120 are joined onto the first end plate 130.

Finally, the positive active material layer 111b, the separator 113, and the negative active material layer 112b are placed in this order on the uppermost bipolar plate 120 of the coupled body in which all the bipolar plates 120 are joined. After that, the second end plate 140 is further placed with the negative electrode lead foil 112a side facing downward.

In this state, the coupled body is fixed, and vibration welding is performed while the second end plate 140 is vibrated in a diagonal direction of the substrate 141. Thus, the second end plate 140 is joined onto the uppermost bipolar plate 120 of the coupled body in which all the bipolar plates 120 are joined.

In this manner, the ends 124a and 125a of the outer reinforcing wall 124 and the inner reinforcing wall 125 are arranged in the vicinity of the facing substrates by joining each of the bipolar plate 120, the first end plate 130, and the second end plate 140 by vibration welding. Then, the outer hollow space EM and the inner hollow space IM are formed.

Note that the flow of performing stacking sequentially from the first end plate 130 toward the second end plate 140 has been described in the above description. However, this stacking order may be conversely set such that stacking is performed sequentially from the second end plate 140 toward the first end plate 130.

### Step of Injection and Chemical Conversion

In the above step of stacking and joining the plates, a joint structure by vibration welding between facing faces of the frames is formed, and an injection hole (not illustrated) is formed by cutout portions of the facing frames. Then, a lid (not illustrated) is attached to cover the injection hole of the bipolar lead-acid storage battery 100.

Then, a predetermined amount of an electrolyte solution is injected from an injection port provided in the lid. The electrolyte solution injected from the injection port is injected into the space C through the injection hole. Thus, the separator 113 can be impregnated with the electrolyte solution. Then, chemical conversion is performed under predetermined conditions. Thereby, the bipolar lead-acid storage battery 100 can be produced.

Note that, for example, as illustrated in FIG. 1, the outer reinforcing wall 124 and the inner reinforcing wall 125 of the bipolar plate 120, and the outer reinforcing wall 134 and the inner reinforcing wall 135 of the first end plate 130, are provided to extend upward in the Z direction from the substrate 121 and the substrate 131, respectively. Therefore, the second end plate 140 is provided with neither an outer reinforcing wall nor an inner reinforcing wall, and the substrate 141 is formed to extend in the X direction.

However, the outer reinforcing wall 124 and the inner reinforcing wall 125 of the bipolar plate 120 are not necessarily formed upward in the Z direction, but conversely, may be formed downward in the Z direction. In this case, the outer reinforcing wall and the inner reinforcing wall are formed downward in the Z direction on the second end plate 140. Accordingly, the substrate 131 of the first end plate 130 is formed to extend in the X direction, and neither the outer reinforcing wall 134 nor the inner reinforcing wall 135 is formed.

Note that the bipolar lead-acid storage battery 100 has been described as an example of an embodiment of the present invention. However, when the above description applies to other storage batteries in which other metals are used instead of lead for current collectors, the application of the above description is not excluded, as a matter of course.

Note that the technology described in the embodiment of the present invention can also adopt the following configurations.

(1) A bipolar storage battery including:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of the positive electrode side and the negative electrode side of each of the cell members, and a frame surrounding a side face of each of the cell members; and
an outer reinforcing wall facing an outer wall face of the frame and extending from the substrate in a stacking direction of the cell members and the space forming member, wherein an outer hollow space is formed between the outer reinforcing wall and the outer wall face.

(2) The bipolar storage battery according to (1), further including an inner reinforcing wall facing an inner wall face of the frame and extending from the substrate in the stacking direction of the cell members and the space forming member, wherein an inner hollow space is formed between the inner wall face and the inner reinforcing wall.

(3) The bipolar storage battery according to (1) or (2), wherein an internal reinforcing member is formed in a hollow space of both or any one of the outer hollow space and the inner hollow space.

(4) The bipolar storage battery according to (3), wherein the internal reinforcing member is in contact with or joined to both or any one of the outer reinforcing wall and the inner reinforcing wall.

(5) The bipolar storage battery according to any one of (1) to (4), wherein the outer reinforcing wall and the inner reinforcing wall are each provided in such a manner that an end in the extending direction is disposed near the substrate adjacent thereto.

(6) The bipolar storage battery according to any one of (1) to (4), wherein the outer reinforcing walls provided on the substrates adjacent to each other are formed in such a manner that ends in an extending direction face each other.

(7) The bipolar storage battery according to any one of (1) to (6), wherein the positive electrode current collector and the negative electrode current collector are made of lead or a lead alloy.

The following is a list of reference signs used in this specification and in the drawings.
100 Bipolar lead-acid storage battery
110 Cell member
111 Positive electrode
112 Negative electrode
111a Positive electrode lead foil
112a Negative electrode lead foil
111b Positive active material layer
112b Negative active material layer
113 Separator
120 Bipolar plate
121 Substrate of bipolar plate
121a Through hole of substrate
122 Frame of bipolar plate
122a Outer wall face
122b Inner wall face
123 Column
124 Outer reinforcing wall
124a End
125 Inner reinforcing wall
125a End
130 first end plate
131 Substrate of first end plate
132 Frame of first end plate
133 Column
134 Outer reinforcing wall
135 Inner reinforcing wall
140 second end plate
141 Substrate of second end plate
142 Frame of second end plate
150 Adhesive
160 Conductor
170 Cover plate
EM Outer hollow space
IM Inner hollow space
C Cell (space accommodating cell member)

What is claimed is:

1. A bipolar storage battery, comprising:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of the positive electrode side or the negative electrode side of each of the cell members, and a frame surrounding a side face of each of the cell members; and
an outer reinforcing wall facing an outer wall face of the frame and extending from the substrate in a stacking direction of the plurality of cell members and the space forming member, wherein an outer hollow space is formed between the outer reinforcing wall and the outer wall face.

2. The bipolar storage battery according to claim 1, wherein an internal reinforcing member is formed in the outer hollow space.

3. The bipolar storage battery according to claim 2, wherein the internal reinforcing member is in contact with or joined to the outer reinforcing wall.

4. The bipolar storage battery according to claim 1, further comprising:
an inner reinforcing wall facing an inner wall face of the frame and extending from the substrate in the stacking direction of the plurality of cell members and the space forming member, wherein an inner hollow space is formed between the inner wall face and the inner reinforcing wall.

5. The bipolar storage battery according to claim 4, wherein an internal reinforcing member is formed in both the outer hollow space and the inner hollow space.

6. The bipolar storage battery according to claim 5, wherein the internal reinforcing member is in contact with or joined to both the outer reinforcing wall and the inner reinforcing wall.

7. The bipolar storage battery according to claim 5, wherein the internal reinforcing member is in contact with or joined to the outer reinforcing wall.

8. The bipolar storage battery according to claim 5, wherein the internal reinforcing member is in contact with or joined to the inner reinforcing wall.

9. The bipolar storage battery according to claim 4, wherein an internal reinforcing member is formed in the inner hollow space.

10. The bipolar storage battery according to claim 9, wherein the internal reinforcing member is in contact with or joined to both the outer reinforcing wall and the inner reinforcing wall.

11. The bipolar storage battery according to claim 9, wherein the internal reinforcing member is in contact with or joined to the outer reinforcing wall.

12. The bipolar storage battery according to claim 9, wherein the internal reinforcing member is in contact with or joined to the inner reinforcing wall.

13. The bipolar storage battery according to claim 4, wherein an internal reinforcing member is formed in the outer hollow space.

14. The bipolar storage battery according to claim 13, wherein the internal reinforcing member is in contact with or joined to both the outer reinforcing wall and the inner reinforcing wall.

15. The bipolar storage battery according to claim 13, wherein the internal reinforcing member is in contact with or joined to the outer reinforcing wall.

16. The bipolar storage battery according to claim 13, wherein the internal reinforcing member is in contact with or joined to the inner reinforcing wall.

17. The bipolar storage battery according to claim 4, wherein the outer reinforcing wall and the inner reinforcing wall are each provided such that an end in an extending direction is arranged in a vicinity of a second substrate adjacent to the substrate.

18. The bipolar storage battery according to claim 1, wherein the outer reinforcing wall provided on the substrate is formed to have an end in an extending direction face an end of a second outer reinforcing wall provided on a second substrate adjacent to the substrate.

19. The bipolar storage battery according to claim 1, wherein the positive electrode current collector and the negative electrode current collector are made of lead or a lead alloy.
